(19) United States
(12) Patent Application Publication
(10) Pub. No.: US 2017/0274285 A1
(43) Pub. Date: Sep. 28, 2017

(54) METHOD AND APPARATUS FOR AUTOMATING THE CREATION OF A PUZZLE PIX PLAYABLE ON A COMPUTATIONAL DEVICE FROM A PHOTOGRAPH OR DRAWING

(71) Applicant: Kiefer Aguilar, Mountain View, CA (US)

(72) Inventor: Kiefer Aguilar, Mountain View, CA (US)

(21) Appl. No.: 14/289,626

(22) Filed: May 28, 2014

(51) Int. Cl. A63F 13/655; G06T 5/00; G06T 7/11; A63F 13/822; A63F 9/06

(52) U.S. Cl. CPC A63F 13/655; A63F 13/822; A63F 9/0612; G06T 7/11; G06T 5/002

(57) ABSTRACT

The automation of a computer playable puzzle pix where the input photographs or drawing.

### CLAIM OF PRIORITY

This patent application claims priority from U.S. Provisional Patent Application No. 61/827,894 filed on May 28, 2013, in the U.S. Patent and Trademark Office, the disclosure of which is incorporated herein by reference in its entirety.

### BACKGROUND

1. Field

Embodiments herein relate to a method and apparatus for exemplary computer playable puzzle pix creation.

2. Description of Related Art

A number of computer applications, including web and mobile device applications, allow users to play and solve puzzle pixes. These applications do not allow users to create puzzle pixes. Rather, the puzzle pixes available to play today are created by manually creating the layout of zones and the list of which zones neighbor one another in the puzzle pix. Because creating a puzzle pix manually is laborious and time consuming, there is a limited number of puzzle pixes available on the market today, with some applications containing as few as 21 puzzle pixes. Furthermore, the puzzle pixes that are available are prone to have incorrect neighbor lists since the manual process of creating them is prone to human error. Together these problems with manual puzzle pix creation cause a frustrating user experience in applications that allow users to play and solve puzzle pixes. Furthermore, user engagement in some applications may suffer because of the limited selection of available puzzle pixes.

Thus, there is a need to automate the creation of puzzle pixes from photographs and drawings to reduce the labor and time needed to create puzzle pixes and to eliminate errors in their neighbor lists. Furthermore, technology to automate the creation of puzzle pixes from photographs and drawings would allow for a infinitude of possible puzzle pixes that are error-free and can quickly be created by users or creators of applications.

### SUMMARY

The invention herein describes and admits an exemplary method for automating the creation of a puzzle pix puzzle playable on a computation device (hereinafter referred to as a “puzzle pix,” or plural “puzzle pixes”) from an ordinary color, grayscale, or black and white image without the need for human intervention. For purposes of this disclosure, puzzle pix is the combination of three items. The first item that constitutes a puzzle pix is a grayscale (sometimes spelled “greyscale”, but hereinafter will be referred to only as “grayscale”) image in which, in one embodiment, white pixels outline simply connected (a.k.a 1-connected) zones (i.e. areas) of non-white pixels with the intent of a player coloring or otherwise labeling zones so that every zone is labeled with one label such that no two “adjacent” zones have the same label. For purposes of this disclosure, a non-white pixel means any grayscale color that is not “pure white” (i.e. “full-white”), e.g. in the RGB color model, non-white grayscale means R=G=B<255. However, it is well known to one of ordinary skill in the art that any two distinct colors may be used to create simply connected regions.

In a puzzle pix, “adjacent” zones are defined as zones which share at least some length of a boundary with one another (that is, two zones which share just one or multiple disjoint points, such as corners, of their respective boundaries with one another are not considered “adjacent”). The second item that constitutes a puzzle pix is a map listing a label for each pixel in the grayscale image, called a “label map” though this term will be defined in more detail later. In the preferred embodiment, and without limitations to other embodiments, each zone is assigned a unique positive non-zero label, and pixels within each zone are assigned the label corresponding to that zone. Pixels belonging to boundaries (white pixels) are assigned a special label of zero. The third and final item that constitutes a puzzle pix is a list of which zones are adjacent to one another, called a “neighbor list”. The neighbor list uses the zones labels to uniquely identify zones. Together these three items constitute a puzzle pix and are sufficient to run a puzzle pix puzzle on a mobile device or any other device with a processor or to create a puzzle pix that may be played in print or other tangible or intangible forms.

For purposes of this disclosure, a user playing a puzzle pix can “label a zone” with any characteristic for differentiating the pixels in one zone from the pixels in another zone. In other words, each zone might be differentiated by visual color, textures, etc.

When a player labels all zones of a puzzle pix with no two adjacent zones having the same label, e.g. color, the puzzle pix is considered to be solved. A player may be asked to solve a puzzle pix with any number of labels, but in the preferred embodiment of a puzzle pix puzzle, the player will be asked to solve the puzzle pix with at least four (4) labels. A puzzle pix is always solvable with four labels according to the Four Color Theorem though fewer labels may be necessary. Additional labels may be requested by the user.

Brief Description of the Drawings

### DETAILED DESCRIPTION OF THE EMBODIMENTS

Example embodiments will be described in detail with reference to the accompanying drawings. Embodiments, however, may be embodied in various different forms, and should not be construed as being limited only to the illustrated example embodiments. Rather, these example embodiments are provided as examples so that this disclosure will be thorough and complete, and will fully convey the concepts of the inventive concepts to those skilled in the art. Accordingly, known processes, elements, and techniques are not described with respect to some of the embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

The puzzle pix creation system may be implemented as a computer system 110; a computer comprising several modules, i.e. computer components embodied as either software modules, hardware modules, or a combination of software and hardware modules, whether separate or integrated, working together to form an exemplary computer system. The computer components may be implemented as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

Input 120 is a module configured to receive an image file. Input file 115a is a digital representation of a drawn (generated) image or a photograph, which may be black and white, grayscale, or color. Neither the input image (photographs or generated) nor the puzzle pix image is limited by any lower or upper size number of pixels aside from device limitations. However, experimentally, for a good user experience on mobile devices such as touch screen phones or tablets, input images such as original photographs and puzzle pix images should have width and height dimensions of at least 100 pixels each.

Input file 115a may be resident on storage device 115, which may be local to computer system 110, e.g. hard drive, on-board resident random access memory, a memory card, etc., or it may be accessible remotely by computer system 110. Input file 115a is stored on a storage device 115 using any number of file formats. One format commonly used is the YUV or Y′UV format. The Y′UV model defines a color space in terms of one luma or brightness (Y′) component and two chrominance (UV) components. Historically, the terms YUV and Y′UV were used for a specific analog encoding of color information in television systems, while YCbCr was used for digital encoding of color information suited for video and still-image compression and transmission such as MPEG and JPEG. Today, the term YUV is commonly used in the computer industry to describe file-formats that are encoded using YCbCr. For purpose of this disclosure, the terms Y′UV and YUV are being used interchangeably and refer to the above referred file formats. There are of course numerous other formats including, but not limited to CMYK, RGB, ARGB, RGBA, BGRA etc.

Input image 120a is a bitmap representation of the image data of input file 115a created by input 120. In the preferred embodiment, all images hereinafter mentioned, including input image 120a, have bitmap representations with 8-bits per pixel per channel. One of ordinary skill in the art of digital image manipulation could change all subsequent steps to use alternative image representations in insubstantial ways. Input image 120a has an RGB format if the input file 115a represented a color image. If the input file 115a represented a grayscale or black and white image image, input image 120a will have a grayscale (single-channel) format.

Image sizer 125 is a module configured to scale input image 120a to create resized image 125a, such that the new size must have integer dimensions most closely preserving the image's original aspect ratio, i.e. the ratio of width to height, to preserve the appearance of the puzzle pix. Failing to do so will cause a distortion of the appearance of the puzzle pix. Image sizer 125 is further configured to resize input image 120a to ensure that the resized image 125a will not have any dimension (width or height) that exceeds memory or processing limits, including texture size limits; currently some devices have hardware or software texture size limits of 2048 pixels in each dimension (width and height). Experimentally, the creation of the puzzle pix should be less than one second if being created by the end-user. Computer system 110 determines the time to create a puzzle pix as a linear function of the number of pixels in the resized image 125a and is inversely proportional to the processing speed of computer system 110.

Image resizer 125 is further configured to ensure that when resized image 125a is smaller than input image 120a, resized image 125a remains large enough to have sufficient detail, i.e. enough that the image can be segmented into Z segments, where Z is the smaller of two numbers, 254 and the number of segments that input image 120a could naturally be segmented into. Since some images are more detailed and/or have a greater number of significant objects (as the brain would. naturally interpret) than other images, the minimum size needed for a meaningful segmentation varies from image to image. The smaller the new size, the less detail will be preserved and the more likely a significant object is obscured, imperceivable, or will be overlooked by the image segmentation in a subsequent step. However, removing some detail in large or highly detailed images is desirable, since the brain may not naturally focus on small objects. Furthermore, it has been experimentally determined that the maximum number of regions a puzzle pix should have for a good user experience is 254, so detail in the resized image beyond what would produce the most significant 254 objects or regions is unnecessary. Experimentally, a resized image 125a with roughly 128,000 total pixels is typically sufficient for the purposes of the resizing requirement.

Image sizer 125 is further configured to scale input image 120a to take advantage of the highest resolution available on the computer system on which the puzzle pix will be played. Resized image 125a should be large enough to occupy the part of the device's display that is desired in an application that runs the puzzle pix's play. For example, on a device with a screen size of 2048 pixels×1536 pixels, the design of an application running a puzzle pix's play may require the puzzle pix to take up an area with dimensions 1700 pixels×1536 pixels. Should resized image 125a be smaller than those dimensions, it would result in a final puzzle pix that would not fill those dimensions without upsampling. Upsampling a raster image results in a pixelated appearance that is not ideal for a good user experience. Thus, it is preferred that that new image size in this example is at least 1700 pixels×1536 pixels. This requirement only applies when reducing the image size, since increasing image size cannot improve the resolution of the original image without pixelation.

Converter 130 is a module configured to convert resized image 125a from color to grayscale. Converting a color image to a grayscale image is well known to one skilled in the art. When performance of is an issue, converting to grayscale is recommended, as it will reduce the computation time in subsequent steps; however, the image segmentation may be less accurate. Converting resized image 125a from color to grayscale is not necessary when resized image 125a is already grayscale (i.e. in the case that input file 115a is grayscale). When resized image 125a is a color image, converting it to grayscale is optional but may be desired for improved performance. If Converter 130 is used, it outputs grayscale image 130a.

Equalizer 135 is a module configured to adjust the intensities of each pixel in either resized image 125a (if Converter 130 was not used) or grayscale image 130a such that the histogram of frequencies of use of grayscale intensities is equalized in equalized image 135a. This process is known as “increasing contrast,” “image equalization,” “histogram equalization,” and simply “equalization”. This process is well within the purview of one of ordinary skill in the art of digital image manipulation. The purpose of this process is to make dark pictures brighter and bright pictures darker. This maximizes intensity differences between pixels, which will enable more sensitive and accurate grouping of pixels in the image segmentation steps.

Should computer system 110 omit converting resized image 125a to grayscale and resized image 125a is a color image, equalizer 135 applies the image equalization solely to the luminance component of the resized image 125a. Equalizing a color image is well within the purview of one of ordinary skill in the art of digital image manipulation.

Blur 140 is a module configured to remove high frequency information from equalized image 135a using a blur filter. In a digital grayscale image, low frequency information refers to places in the image where the intensity is relatively uniform, i.e. there aren't any abrupt changes in the intensity. By contrast, high frequency information refers to those areas where there is a substantial and sharp change in the intensity, such as the transition points between different objects in an image. Applying this Blur Filter is well within the purview of one of ordinary skill in the art of digital image manipulation and is necessary to reduce the high frequency information in the image in preparation for the subsequent step of image segmentation. In the preferred embodiment, a Gaussian Blur Filter with a radius of “a1” pixels is applied, where a1 is the maximum of 2 and a the largest number smaller than the square root of a fraction, the numerator of which is the number of pixels in equalized image 135a and the denominator of which is 56,000. The result of blur 140 is the blurred image 140a.

Segmenter 145 is a module configured to segment blurred image 140a. In computer vision, image segmentation is the process of partitioning a digital image into multiple segments, i.e. contiguous group of pixels, a.k.a. superpixels, of the same color in the segmented image. In the subsequent step of image segmentation, boundaries between segments are drawn in locations of high frequency. For example, an object in an image will typically have central areas of low frequency information surrounded by a thin boundary area of high frequency information. For purposes of this disclosure an area refers to a contiguous group of pixels. Since the goal of image segmentation is to group pixels that belong to an object, algorithms for image segmentation will generally place boundaries between segments along locations of high frequency. Unfortunately, some textures, which the human brain may recognize as belonging to one object, contain regions of high frequency information (called “noise”) as well. True object boundaries usually have a thin boundary of high frequency information, while textures may have entire areas of high frequency noise. Reducing high frequency information in the image with blur 140 reduces high frequency noise more than high frequency boundaries, thereby aiding segmenter 145 in identifying true object boundaries. If segmenter 145 were to apply an image segmentation routine directly to the un-blurred image (i.e., equalized image 135a), numerous errors would occur in regions of high frequency noise. Therefore, computer system 110 executes blur 140 prior to segmentation.

The result of image segmentation is a set of mutually-exclusive segments that collectively cover the entire image (that is, are collectively exhaustive). Each of the pixels in a segment is similar with respect to some combination of characteristics or computed properties, such as color, intensity, or location. Adjacent regions are significantly different with respect to the same characteristic(s). Although a plurality of segmentation algorithms exists, in the preferred embodiment, a pyramid segmentation algorithm is used to group related pixels. Any segmentation algorithm may be used but it must have the following characteristics: it must attempt to segment the image in a way that the brain naturally does (that is, how the human brain interprets the boundaries of objects from one another); it must result in segments colored with a color that approximates the colors of the corresponding pixels in the pre-segmentation image.

The resulting segmentation image 145a is typically relatively detailed, typically has more than 254 segments, and may have some segments that are smaller than the minimum region size required for a puzzle pix as described later.

Smoother 150 is a module configured to smooth the edges of the segments in segmentation image 145a through dilation and erosion filters. Applying dilation and/or erosion filters is known to one or ordinary skill in the art of image processing.

In the preferred embodiment, smoother 150 applies one erosion followed by one dilation, known in computer vision as an opening. However, there are numerous combinations of erosions and dilations that would be effective. In another embodiment, the sequence of dilation and erosion Filters applied is (1) erosion, (2) dilation, (3) dilation, and (4) erosion. Dilation expands brighter (higher luminance) segments and contracts darker (lower luminance) segments, while erosion contracts brighter (higher luminance) segments and expands darker (lower luminance) segments. The resulting image is a smoothed image 150a.

Smoothed image 150a is an image with simply connected segments, each of which is colored a (possibly non-unique) color. In puzzle pixes, segments must ultimately be uniquely identified and must thus be labeled uniquely. Labeler 155 is a module configured to uniquely label the segments found in smoothed image 150a. Unique labeling of segments is accomplished in a separate map of labels, hereinafter called the “preliminary label map 155a,” one label for each pixel in the image, such that each segment is assigned a unique non-negative label and such that pixels are labeled according to the segment to which they belong. For purposes of this disclosure, the format of a label map, including, but not limited to the preliminary label map 155a, may be any such that there is a one-to-one correspondence between labels and pixels in a given image called a “corresponding image”. In the case of the preliminary label map 155a the corresponding image is smoothed image 150a.

The preferred format of a label map is a bitmap image of the same dimensions as the corresponding image with pixel values in the image constituting a numeric label in binary format. For example, the pixel value (11, 137) in a 2-channel image has a binary format 0000101110001001 that corresponds to the decimal (base 10) label value 2,953. There are many other representations of a label map that could work, including non-bitmap representations. However, hereinafter the assumed format of any label map described herein is the preferred bitmap format. Adapting subsequent steps to use a label map of another format is well within the purview of one of ordinary skill in the art of digital image manipulation.

Label maps may need to represent label values greater than the number of unique values allowed in a single 8-bit per pixel image channel. For example, the result of the segmentation and smoothing processes is a set of segments, possibly greater in number than the number of unique values allowed in a single 8-bit image channel (256), and thus the preliminary label map would need to represent more than 256 labels. Thus, multiple image channels may be necessary in label maps. Hereinafter, it is assumed that label maps add additional image channels as needed to represent the highest assigned label.

To accomplish the creation of the preliminary label map 155a, the labeler 155 iterates through pixels in the smoothed image 150a. For each pixel, “P”, if “P” has been assigned a non-zero label, the iteration immediately continues to the next pixel. Otherwise, a flood fill algorithm (a.k.a. a seed fill algorithm, or a boundary fill algorithm) using “P” as the seed pixel is used to find all pixels in the outline image that belong to the same region that “P” does and simultaneously assigns each pixel in the region the same integer label (the next sequential integer label that has not been used for any other region, starting with the label 1 for the first region). The flood fill algorithm, which is easily applied by one skilled in the art, also provides the number of pixels belonging to the region.

For purposes of this disclosure a “region” refers to a contiguous group of pixels in a label map with the same label. In the preliminary label map 155a, all pixels belonging to a given region belong to the same segment and vice versa. Additionally, all pixels in a given region have the same unique label, and all pixels in a given segment have the same color, possibly non-unique among the colors of other segments.

As pixels in the preliminary label map 155a are being labeled, the invention records four descriptors, hereinafter called the “preliminary region descriptors 155b,” for each region: (1) the “primary label,” which uniquely identifies the region, (2) the “pixel count,” the number of pixels belonging to the region, (3) the “color” of the pixels corresponding to the region in the smoothed image 150a, and (4) a list of “sub-labels” which for now contains only the label assigned to the region and is a list that will subsequently be further defined and used.

Neighbor finder 160 is a module configured to create a “preliminary neighbor list 160a” which is an initial unrefined list of neighbor pairs of regions in the preliminary label map 155a. A “neighbor pair” is a pair of regions that are considered neighbors with one another. Two pixels are considered “contacting” if they share a pixel face (that is, a full side of one pixel touches a full side of the other). Two regions are considered “contacting” if any pixel from one region is contacting any other pixel from the other region.

As preliminary neighbor list 160a is initial and unrefined, the requirement for considering two regions to constitute a neighbor pair is merely that they are contacting one another (as opposed to requiring the regions to share a boundary length with one another longer than one pixel face). This not only reduces processing time for the preliminary neighbor list, but also preserves accuracy and consistency of neighbors in subsequent steps as regions are merged with one another. For example, if more than one pixel face were required for the designation of neighbors, it is possible that before merging regions G and H, neither G nor H were neighbors to region J, but that after merging G and H, the merged region GH is now a neighbor of J. In subsequent steps, the designation of neighbor is given only to regions that contact one another over longer lengths of contact.

“Edge pixels” are pixels involved at points of contact between two regions. An edge pixel is defined a pixel assigned any non-zero label that is contacting at least one other pixel of a different non-zero label. An “edge” is the set of all edge pixels in a given region. A “trace” T(U,V) is a set of edge pixels in a first region U that are all contacting at least one edge pixel of a second region V. An edge pixel may belong to multiple traces if it contacts edge pixels from multiple different regions. When edge pixels of two different regions contact one another, the lines of contact between the two regions, i.e. between pixels, constitute a “border”.

Neighbor finder 160 performs two tasks simultaneously: (1) it determines which regions are neighbors, and (2) it lists the locations of all edge pixels in separate sets, one set for each trace in the preliminary label map 155a. Any format of edge pixel locations is acceptable, such as pixel co-ordinates, but the preferred embodiment of neighbor finder 160 uses a pointer value (the memory location) of the pixel in the preliminary label map 155a which enables quick access to the label value for that pixel. The edge pixels organized by trace will be used in subsequent steps to determine the “strength of neighborship” between neighboring regions and to help decide how to merge small regions into larger ones. Listing and organizing edge pixels by trace saves computational time in these subsequent steps, because rather than search through all pixels in the preliminary label map 155a to determine if a pixel is an edge pixel and if so what trace it belongs to, the neighbor finder 160 can immediately access all the pixels of a trace and their labels.

Neighbor finder 160 iterates through all pixels in the preliminary label map 155a to find all edge pixels. When it finds an edge pixel, it determines which trace(s) it belongs to, and lists the pixel in that trace, listing the same edge pixel in multiple traces if needed. At the end of this iteration, the neighbor finder 160 lists which regions neighbor one another in the preliminary neighbor list 160a by determining which traces contain at least one edge pixel (each non-empty trace indicates a neighbor pair).

The resulting output is (1) the preliminary neighbor list 160a, and (2) a set of edge pixels for each trace (or simply, a list of edge pixels organized by which pair of regions each edge pixel contacts a border of). These sets of edge pixels will collectively be called “preliminary traces 160b.”

The concept of neighborship is “symmetric.” That is, if region X is a neighbor to region Y, then region Y is a neighbor to region X. Thus, to save memory and computational time, the preliminary neighbor list should only list neighbor pairs once. For example, if the neighbor list has listed region Y as a neighbor of region X, it should not list region X as a neighbor of region Y. This reduces the length of the neighbor list by a factor of two. For computational operations that are of time complexity O(n̂2) or slower, reduces computational complexity and time by a factor of four or better. For computational operations that are of time complexity O(n), reduces computational complexity and time by a factor of two.

The principle of “solving” a puzzle pix (labeling neighboring, i.e. adjacent, zones during puzzle pix play so that no two neighboring zones have the same label) is based on the Four Color Theorem which requires zones that are considered neighboring to be touching by a contiguous length of border, not just by isolated points, e.g. corners. While technically regions contacting by a single pixel face or by a small number of pixel faces is a non-zero contiguous length, such regions may not visually appear to be neighboring by an contiguous length to the human eye, and would thus create a confusing user experience if such regions (and their corresponding zones in puzzle pix play) were considered neighbors.

Strength finder 165 is a module configured to calculate the “strength of neighborship” for each neighbor pair. Strength of neighborship is a measure of the length, as perceived by the human eye, of the longest contiguous border between neighboring regions subject to an upper bound as will be discussed later. Strength of neighborship is not the actual length of the longest contiguous border between neighboring regions since the actual length may be larger than what the human eye perceives when borders are particularly jagged. Any of several units may be used, but it is preferred that strength of neighborship is measured in units of pixels. In subsequent steps, some neighboring regions may be merged with one another, two regions at a time. Since some regions that will be merged may be neighbors to multiple regions, a determination of which neighbor pairs to merge must be made. One factor in that determination is strength of neighborship.

For each neighbor pair, region A and region B, strength finder 165 determines the strength of neighborship between two regions as follows. Region A and region B contain traces T(A,B) and T(B,A), respectively. Each of these traces may contain any number of “frontiers.” A “frontier” is a subset of the pixels in a trace in which either of the following is true: (1) every pixel in the frontier is touching at least one other pixel in the frontier, or (2) the frontier contains exactly one pixel member, which is not touching any other trace pixel in the same region. Two pixels are considered “touching” if they are contacting one another, i.e. share one common pixel face, or if they share at least one common pixel corner.

The strength of neighborship between regions A and B is the greater of two numbers: (1) the number of pixels in the longest frontier of T(A,B), or (2) the number of pixels in the longest frontier of T(B,A), where the length of a frontier is the number of pixels in the frontier. However, because past a certain frontier length neighboring regions are clearly visibly neighboring one another to the human eye, any frontier length larger than “N1” pixels is considered equivalent, where N1 is the number of pixels that it takes the human eye to clearly see that a frontier is a contiguous length of border between regions. The value of N1 depends on the size of the image.

Experimentally, one acceptable value for N1 is the first integer greater than or equal to the square root of a fraction, the numerator of which is the number of pixels in the resized image 125a (or in the preliminary label map 155a, since they have the same size) and the denominator of which is 6,000.

Strength finder 165 uses the preliminary traces 160b to calculate the strength of neighborship for each neighbor pair, henceforth called “strengths of neighborship 165a” or sometimes simply “strengths 165a”, according to the preliminary neighbor list 160a, such as Region A and Region B. Strength finder 165 calculates frontier lengths from a copy of either one of the traces involving these regions, T(A,B) or T(B,A), by sorting edge pixels in that trace into frontiers. As the edge pixels are sorted and added to frontiers, if any frontier length reaches N1 pixels, no further frontier lengths are calculated and the pair of regions is assigned a strength of neighborship in strengths 165a of N1 pixels. Otherwise, the sorting of edge pixels continues until the trace runs out of pixels, and the maximum frontier length is noted for later comparison. Then the same process is performed with a copy of the other trace involving these regions. If any frontier length reaches N1 pixels, again no further frontier lengths are calculated and the pair of regions is assigned a strength of neighborship in strengths 165a of N1 pixels. Otherwise, the sorting of edge pixels continues until this trace runs out of pixels, and the pair of regions is assigned a strength of neighborship in strengths 165a equal to the greatest frontier length from both traces. Thus, no pair of regions is ever assigned a strength of neighborship exceeding N1.

To sort pixels from the copy of a trace into frontiers, strength finder 165 uses the following process. It removes any pixel from the trace and uses it as a seed pixel for a new frontier. Strength finder 165 uses a flood fill algorithm (a.k.a. a seed fill algorithm, or a boundary fill algorithm) on the preliminary label map 155a to find other trace pixels that belong to the same frontier as the seed pixel. When the strength finder 165 adds a pixel to a frontier, it then tests pixels touching the added pixel to determine if they should also be added to the frontier. A pixel should be added to a frontier if it is found in the trace and is touching at least one other pixel in that frontier. When a pixel is added to a frontier, it is removed from the trace. When the strength finder 165 finds no additional pixels that belong to the frontier, the process repeats on any pixels remaining in the trace until there are no more pixels in the trace.

Merger 170 is a module configured to merge the smallest “N2” regions in the preliminary label map 155a with neighboring regions, where N2 is calculated so that regions that are too small are merged by Merger 170. A region is too small if it contains less than “N3” pixels, where N3 is the total number of pixels in the preliminary label map 155a divided by the number of allowable regions. Experimentally 254 is a visually appealing number of allowable regions. Further, by limiting the number of regions to 254, a label map reflecting the merged regions can be represented in a single-channel (grayscale) bitmap image where each pixel is assigned a grayscale intensity value that represents a label of one of 254 values, e.g. 1 to 254, inclusive, and where one value, e.g. 0, will be used later to represent a pixel that belongs to a region boundary and second value, e.g. 255, is unused in a puzzle pix created from a photograph. More than 254 regions may be allowed, but additional channels would be needed to represent such a label map. Merger 190 calculates N2 by counting the number of regions in the preliminary region descriptors 155b that have pixel counts smaller than N3.

In a puzzle pix that is created from a drawing with a process described later herein, a special label value (in the preferred embodiment, 255) is reserved for a pixel that is considered neither part of a region nor part of a region boundary (an “un-colorable pixel” as will be later described). For simplicity in designing application software that runs puzzle pixel, the same application software runs puzzle pixes created from both photographs and drawings, and therefore the special value 255 is left unused when creating a puzzle pix from a photograph.

Because in creating the preliminary neighbor list, two regions were considered a neighbor pair if the regions are contacting (even if by just one pixel face of contact), the following are true:

If neither region G1 nor region H1 neighbors region J1, region G1H1, created by merging region G1 and region H1, will also not be a neighbor to region J1.

If either or both region G1 and region H1 are neighbors to region J1, region G1H1 will also be a neighbor to region J1.

Thus, when regions are merged, merger 170 updates the preliminary neighbor list 160a deterministically, i.e. according to the above rules without having to search again through the preliminary label map 155a for contacting regions, which would be computationally expensive.

While one contacting pixel face is sufficient for two regions to constitute a neighbor pair, merging two regions contacting only by one or a small number of pixel faces is confusing to the user because such a small boundary of contact may appear more like a corner (or isolated point) that is common to the two regions. Furthermore, when boundary lines between regions are drawn in an outline image in a subsequent step, the thickness of those lines may cause separate boundary lines on opposite ends of the contacting boundary to appear as one. To the user this would appear as two separate regions, while the puzzle pix application software would treat it as one merged region. To avoid this problem, when merging a given small region with any of its neighbors, merger 170 will merge the region with the neighbor with the highest strength of neighborship.

Merger 170 merges regions two at a time. In each merge operation, one of the regions merger 170 merges will be the smallest existing region, region G2, at the time of the merge. The other region Merger 170 merges, region H2, will be a region neighboring G2 that has the highest strength of neighborship of all regions that neighbor G2. It is typical for the highest strength of neighborship to be shared among a set, W, of multiple regions neighboring G2 because the strength of neighborship is capped at N1 pixels. In this situation, Merger 190 merges G2 with the region in W that has the closest color to the color of G2. After a merge operation, merger 170 creates one newly merged region, region J2. The result of Merger 170 is a set of regions with boundaries that are more like what the brain naturally determines are object boundaries versus a merging process that merges a small region with an arbitrary neighbor region.

Merger 170 updates the preliminary region descriptors 155b by adding descriptors for J2 as follows:

Set the pixel count of J2 to the sum of the pixel counts of G2 and H2. The purpose of keeping the pixel count of J2 is for use as a weight when calculating the color of subsequent merges involving J2.

Set the color of J2 to the weighted average of the colors of G2 and H2 using their pixel counts as weights. The purpose of keeping an average color for region J2 is to ensure regions of like colors are merged together with J2 before regions of dissimilar color in any subsequent merge operation involving J2.

Set the primary label of J2 to the primary label of either G2 or H2. The purpose of keeping a primary label for J2 is to ensure that it has a unique identifier. Merger 170 uses this unique region identifier to update the preliminary neighbor list 160a in the process described previously.

Set the sub-labels of J2 to the union of the sub-labels of G2 and H2. The purpose of merging the sub-labels is to keep a list of all the labels that pixels within J2 may have in the preliminary label map 155a.

After the descriptors for J2 have been created, the descriptors for G2 and H2 are no longer needed. Because the boundary of J2 is new and because the regions neighboring J2 may now have a new strength of neighborship with J2 that is different than their strengths of neighborship with G2 or H2 before the merge, Merger 170 updates the strengths of neighborship between J2 and its neighbors in strengths 165a after each merge. The neighbors of J2 are “affected regions.” After all merge operations, the updates to strengths 165a create a new “updated strengths of neighborship 170a”, which may henceforth be alternatively called “updated strengths 170a” for brevity. Similarly, after all merge operations, the updates to the preliminary region descriptors 155b and to the preliminary neighbor list 160a create the “updated preliminary region descriptors 170b” and “updated preliminary neighbor list 170c”, respectively.

To update the strengths of neighborship 165a between the affected regions and J2, Merger 170 updates the traces belonging to the affected regions and belonging to J2 in the preliminary traces 160b, and then using the updated traces, the strength of neighborship between J2 and the affected regions is calculated as before. These updated strengths of neighborship are needed to determine which regions should be involved in subsequent merge steps. After all merge operations, the updates to preliminary traces 160b collectively create the “updated preliminary traces 170d”.

Merger 170 updates traces in J2, i.e. traces containing pixels in J2 and contacting pixels of affected regions, in the following process: For every region, R1, that neighbors J2, the trace T(J2,R1) is the union of traces T(G2,R1) and T(H2,R1) since both G2's and H2's trace pixels with R1 remain trace pixels with R1 after the merge and now all belong to region J2. The traces T(G2,H2) and T(H2,G2) are no longer utilized after the merge because G2 and H2 no longer border one another but are now part of the same region J2.

Merger 170 updates traces in the affected regions, i.e. traces containing pixels in the affected regions and contacting pixels of J2, in the following process: For every region, R2, that neighbors J2, the new trace T(R2,J2) is the union of traces T(R2,G2) and T(R2,H2) since R2's trace pixels with G2 and H2 are still pixels that belong to R2 and since they all contact the merged region J2.

At this point, computer system 110 has generated with (1) the preliminary label map 155a, (2) the updated strengths of neighborship 170a (3) the updated preliminary region descriptors 170b, (4) the updated preliminary neighbor list 170c, and (5) the updated preliminary traces 170d. These five things will hereinafter be called “preliminary products.” The preliminary label map 155a will contain as many regions as segments that are naturally created from the image segmentation and smoothing processes, i.e. segments in smoothed image 150a, but not the region merging process since it was never updated in the merging process. The updated strengths of neighborship 170a lists the strengths of neighborship for every neighbor pair after the merging process. The updated preliminary region descriptors 170b describe the characteristics of the regions after the merging process: the number of pixels belonging to each region, the color that best represents the color of the pixels corresponding to each region in the blurred image 140a, a unique primary label for each region, and the list of all sub-labels that each region contains. The sub-labels for a given region lists labels that pixels belonging to the region might have in the preliminary label map 155a. The number of regions in the updated preliminary region descriptors 170b is typically large enough to constitute a puzzle pix that is challenging to solve for most users. Additionally, the updated preliminary region descriptors 170b will not describe small regions (regions with small pixel counts) that are hard for users to touch with a finger or see on a device's screen, so as to facilitate a pleasant user experience. The updated preliminary neighbor list 170c is a neighbor list that describes neighborship of regions in the updated preliminary region descriptors 170b, i.e. after the merging process. The updated preliminary traces 170d is a set of traces listing edge pixel locations in each region after the merging process. The preliminary products will be used as starting points for further processing in response to user difficulty adjustment without the need to re-compute them.

The difficulty adjustment system, computer system may be implemented as further modules to computer system 110; a computer comprising several modules, i.e. computer components embodied as either software modules, hardware modules, or a combination of software and hardware modules, whether separate or integrated, working together to form an exemplary computer system. The computer components may be implemented as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

Difficulty selector 220 is a module configured to receive input from the user selecting the difficulty of the puzzle pix. The difficulty level desired may be specified in a number of ways by the user, but one simple way is to have a slider that the user can adjust. When the slider marker is positioned at one end of the slider, the maximum difficulty is indicated. When positioned at the other end of the slider, the minimum difficulty is indicated. All intermediate positions represent intermediate difficulties, linearly, logarithmically, etc. interpolated (for example), between the maximum difficulty and minimum difficulty. Ultimately, the difficulty level indicated by the user must be converted into the number of regions to merge with neighboring regions. For a good user experience, it has been experimentally determined that the resulting number of regions should be no less than 8 (that is, all but “nr” regions should be merged away with nr≧8). The minimum number of regions to merge is, of course, 0, which would result in the same region descriptors and neighbor list as the updated preliminary ones in the preliminary products.

Copier 230 is a module configured to make a working copy of the preliminary products. Subsequent processing will be performed using these copies, so that these working copies may be altered while allowing the user to later select a different difficulty without having to reprocess the input file to re-calculate the preliminary products. These working copies will now be referred to as the label map 230a (copy of preliminary label map 155a), the region descriptors 230b (copy of updated preliminary region descriptors 170b), the neighbor list 230c (copy of updated preliminary neighbor list 170c), traces 230d (copy of updated preliminary traces 170d), and strengths of neighborship 230e (copy of updated strengths of neighborship 170a). Strengths of neighborship 230e may henceforth alternatively be referred to as “strengths 230e” for brevity.

Merger 240 is a module identical to merger 170 and configured to merge small regions using the copied preliminary products as described above, where the number of regions to merge N2 is calculated by difficulty selector 220. The “updated region descriptors 240a” (called the updated preliminary region descriptors 170b) is the only product from merger 240 that will be used in subsequent steps.

Simplifier 250 is a module configured to simplify the primary labels in the updated region descriptors 240a. After merger 240 has finished merging small regions, the primary labels in the updated region descriptors 240b are unique. However, they may be any value. According to one embodiment, Simplifier 250 changes the values of the primary labels to sequential non-zero positive integers, from 1 to the number of total regions. This change is made to the primary labels in the updated region descriptors 240a to create updated region descriptors 250a. This step merely “renames” regions, while maintaining identical information about the descriptors of those regions. Which regions are assigned what new primary label does not matter. The advantage to this labeling scheme is that now the simplified label map 260a, which will be described herein, can be represented in the format of a single-channel (grayscale) image.

Simplifier 260 is a module configured to simplify the preliminary label map 155a. The preliminary label map 155a contains labels that are contained in the sub-labels lists in the simplified region descriptors 240a. Simplifier 260 simplifies the preliminary label map 155a by changing the labels for each pixel to the corresponding new primary label of the region that pixel belongs to. A pixel “PP” belongs to region “R3” if the label of that pixel in the label map is any of the sub-labels of region R3 in the simplified region descriptors 250a; region R3's new primary label is then assigned to pixel PP in the preliminary label map 155a to create the simplified label map 260a, hereinafter simply referred to as label map 260a. The purpose of the label map 260a is to have a label map where all pixels have only primary labels and where all pixels belonging to a region have the same label for use in subsequently calculating region boundaries.

Since in the preferred embodiment, there are no more than 254 primary labels, and since the primary region labels are sequential integers starting from 1, the label map 260a can be represented in the format of a single-channel(grayscale) image. The simplified region descriptors 250a are no longer needed now that all pixels have been relabeled with primary labels in the label map 230a.

Imager 270 is a module configured to create outline image 270a. In order for the user to know if further difficulty adjustment is needed, an outline image of the boundaries of the regions in the puzzle pix at the current difficulty level is displayed to the user. According to one embodiment, this image is a grayscale image that has full-white pixels representing boundaries of regions and non-white pixels, mostly full-black pixels, but some gray pixels may exist next to the boundary pixels for anti-aliasing the boundary so that it appears smooth, representing the interiors of regions.

At the beginning of the process, Imager 270 designates all pixels in the outline image as full-black. While merely coloring white each pixel in the outline image that corresponds to an edge pixel in the label map 260a would create an outline image, such an outline image would potentially have two problems: (1) the outlines around regions might appear too thin to the user since they are only approximately two pixels thick in most boundaries (since the boundary is constituted by one single-pixel thick boundary of edge pixels in one region, and another single-pixel thick boundary of edge pixels in the neighboring region), and (2) the outlines around regions would appear pixelated since all pixels in the outline image would be either full-white or full-black with no easing or smoothing the boundary, which is especially visible when the boundary contains curves.

Thus, rather than simply color the pixels in the outline image 270a that correspond to edge pixels in the label map 20a white, Imager 270 creates thicker smoother lines. While there are many methods well-known to one skilled in the art that can thicken and smoothen drawn lines, in the preferred embodiment Imager 270 determines the edge pixels in the label map 260a and, for each edge pixel, “paints” a white anti-aliased circle of radius “z” pixels centered over the pixel in the outline image 270a corresponding to the edge pixel in the label map 260a. Imager 270 starts with a black image and then in painting each circle, the colors of the pixels that the circle is painted onto is set to the maximum of two grayscale pixel values: (1) the existing value of the pixel, and (2) the pixel value in the anti-aliased circle that is being painted onto the pixel.

Since all pixels in the outline image that correspond to edge pixels in the label map must be full-white, if the value of z used is so small that the central pixel is painted a grayscale value less than 255 (that is, if the color is not full-white), Imager 270 overrides this with the full-white pixel value 255. This process creates smooth boundary lines that appear to have a thickness, “D”, of 2z+1 pixels or 2 pixels, whichever is greater. Mathematically, D=max(2z+1, 2). The value of z may be any positive real number (including non-integers). Experimentally, one value of z that creates outline lines that are thick enough for the user to clearly see without being so thick that the contours of regions are visually distorted is the square root of a fraction, the numerator of which is the number of pixels in the label map 260a, and the denominator of which is 160,000.

The result is the grayscale outline image 270a at the current difficulty level set by the user. The outline image will have 3 characteristics: (1) region boundaries colored white that are thick enough for the user to easily see, (2) region interiors which are colored with non-white pixels (most pixels being colored black except near the region boundaries), (3) region boundaries that appear smooth and are more attractive to the user than pixelated sharp boundaries, but where only full white pixels will be considered part of region boundaries in subsequent processing.

The puzzle pix creation system may be implemented as a computer system 310; a computer comprising several modules, i.e. computer components embodied as either software modules, hardware modules, or a combination of software and hardware modules, whether separate or integrated, working together to form an exemplary computer system. The computer components may be implemented as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

Labeler 320 is a module configured to create final label map 320a and final outline image 320b once the user difficulty has been selected. Labeler 320 uses the previously generated outline image 270a which is a grayscale image with full-white boundaries and non-white regions.

In the final label map 320a, labeler 320 assigns each pixel a label with all the pixels belonging to a region having the same label. The labels assigned to the pixels of a region are unique to that region, and together, in one embodiment, all the regions assigned are sequential integers starting from 1. The special label of zero is assigned to full-white boundary pixels. The process of creating an outline image may have inadvertently created additional regions because boundaries were thickened, there is no guarantee that the number of regions will be no larger than the maximum allowed, e.g. 254. Additionally, there is no guarantee that regions contain at least a certain number of pixels.

As previously discussed having small regions in the final label map 320a is not a good user experience, so regions that are too small, that is, regions that contain less than a threshold number of pixels “N4” are simply treated as if all pixels belonging to that region are boundary pixels. Experimentally, no region should contain more than 1/254th of the total number of pixels in the puzzle pix. Thus, this determination gives rise to a value of N4 that is the highest integer less than a fraction, the numerator of which is the number of pixels in the outline image 270a, and the denominator of which is 254.

A “domain” is a contiguous group of non-white pixels in an outline image, including outline image 270a and the final outline image 320b. In the outline image 270a, small domains are handled by assigning the label 0 to corresponding pixels in the final label map 320a and ignoring such domains, in creating the final neighbor list, as will be described later. Labeler 320 updates the outline image 270a to create the final outline image 320b by filling in small domains with full-white pixels to indicate to the user that they do not constitute a region that can be labeled when playing the puzzle pix. This treatment of small domains guarantees that there will be no more than 254 regions in the final label map 320a and the final neighbor list, which will be described later.

To accomplish the creation of the final label map 320a while simultaneously identifying small domains, labeler 320 applies a flood fill algorithm on the outline image 270a to label the corresponding pixels in the final label map 320a, assigning all pixels corresponding to the same domain the same positive integer label, and assigning all pixels corresponding to boundaries in the outline image 270a, i.e. full-white pixels in the outline image 270a, the label 0. A flood fill algorithm is easily applied by one of ordinary skill in the art of image processing. Each region in the final label map 320a is assigned the lowest positive integer label that has not been assigned to another region. For purposes of this disclosure assigning a region a label means assigning every pixel in that region the same label. Labeler 320 also counts the number of pixels belonging to each region, which when smaller than the threshold of N4 pixels indicates that the corresponding domain in the outline image 270a is too small and should be ignored. All pixels in ignored domains are colored full-white to create the final outline image 320b, and the corresponding pixels in the final label map 320a are assigned the label 0. The non-zero label that had been initially assigned to the pixels of this region is then again available for use in subsequent regions. Since there are at most 254 regions in the final label map 320a, in the preferred embodiment the final label map 320a need only represent the labels 0 to 254, inclusive, which may be accomplished with a single-channel grayscale image.

The result of labeler 320 is (1) final label map 320a with no more than 254 regions labeled with positive non-zero integers and with boundaries labeled with the special label 0, and (2) final outline image 320b that is essentially identical to outline image 270a except that small domains are filled in as white boundaries. These two components constitute two of the three components that constitute the final puzzle pix. The remaining component is the final neighbor list, which the subsequent steps will create.

As previously discussed, the principle of “solving” a puzzle pix (labeling neighboring, i.e. adjacent, regions so that no two neighboring regions have the same label) is based on the Four Color Theorem which requires regions that are considered neighboring to be contacting by a visually identifiable length of boundary between them, not just by isolated points, i.e. corners. Thus, the final neighbor list must reflect which regions are visually identified as neighbors, which in subsequent steps will be determined by testing whether a given pair of regions has a strength of neighborship, as defined previously, larger than a threshold to be considered a neighbor pair.

A prerequisite to calculating the strength of neighborship between regions is to have organized lists of edge pixels (frontiers) at the borders between regions. However, in the final label map 320a, regions are separated by boundaries containing pixels of label 0, and therefore, there are no borders or edge pixels between regions, i.e. no pixel in any region contacts any pixel from any other region. Eliminating boundaries between regions by assigning boundary pixels the label of the closest region will create edge pixels and borders between neighboring regions, from which, after some additional processing later described, a strength of neighborship may be calculated.

Pixel lister 330 is a module configured to label and list boundary pixels in the copy of the final label map 320a, called the border label map 330a. The purpose of copying the final label map 320a to create the border label map 330a is to preserve the final label map 320a as one of the three final components of the puzzle pix, while creating a working copy of the final label map 320a that can be modified. Pixel lister 330 simultaneously extends the pixel labeling to boundary pixels in the border label map 330a (pixels that correspond to pixels in the final label map 320a that have a label of 0) and creates a list of boundary pixel locations 330b in the border label map 330a as Pixel lister 330 iterates through the pixels of the border label map 330a and finds boundary pixels. The purpose of creating a list of boundary pixel locations to optimize processing speed in subsequent processes so that boundary pixels do not need to be found again in the border label map 330a. Any format of the list of locations is acceptable, such as pixel co-ordinates, but in the preferred embodiment of the Pixel Lister 330, boundary pixel locations 330b are pointer values (the memory locations) of pixels in the border label map 330a which enables quick access to the label value for that pixel.

Each boundary pixel “BC” in the border label map 330a has a corresponding pixel “BD” in the final label map 320a. Pixel Lister 330 assigns “BC” the label of the “closest” pixel in the final label map 320a to “BD” within a radius, r, which has a non-zero label. Here, according to this embodiment, and without limitations towards other embodiments, “closest” is defined as the Euclidean distance between pixel centers measured in pixel lengths. The search for a closest pixel is limited to radius r both to reduce computational time and to not label boundary pixels that are distant from all regions in the final label map 320a, such as pixels that correspond to pixels in the final outline image 320b that are highly interior to domains that were too small and were filled with white pixels previously. Pixel lister 330 excludes such boundary pixels, called “interior boundary pixels,” because the user would not visually interpret such pixels as belonging to the boundaries between regions and thus they will not be used to determine which regions are neighboring one another.

If the value of r is too small, some boundary pixels in border label map 330a that correspond to white pixels in outline image 270a may not be assigned a non-zero label. In particular, boundary pixels in border label map 330a that are near corner points where more than two regions meet and those in the middle of boundaries between two regions may not be assigned non-zero labels by Pixel lister 330. While it is okay for boundary pixels near corner points not to be assigned a non-zero label since they do not visually contribute to lengths of boundaries between regions but rather correspond to corners, it is problematic for pixels that lie on boundaries that separate just two regions (not near corners) not to be assigned a non-zero label. Thus to avoid such pixels not being assigned a non-zero label, r must be an integer that exceeds 50% of the thickness of the outlines, D, in the outline image 270a as previously described. Furthermore, since curves in the outlines can effectively make them slightly thicker, experimentally, r should be an integer at least 75% of D.

If the value of r is too large, too many pixels in the border label map 330a that correspond to pixels in small domains that were filled with white pixels in the final outline image 320b will be assigned non-zero labels by pixel lister 330, which can cause the pixel lister 330 to identify pairs of regions that visually neighbor the filled domain but not each other as neighbors, which would be confusing to the user. To minimize the chances of this happening, r should be as small as possible so long as boundary pixels that are truly part of region boundaries get labeled. Thus, experimentally, the optimal value of r is the smallest integer greater than or equal to product of 0.75 and D.

Frequently, multiple pixels in the final label map 320a with non-zero labels are all equidistant to BD, are all the closest pixels with non-zero labels to BD, and are all within a radius of r to BD. Therefore, the pixel lister 330 labels BC as follows:

Pixel lister 330 defines the set S1, the set of all closest non-zero labeled pixels in the final label map 320a to BD within a radius r around BD.

Pixel lister 330 defines the set L1, the set of all the labels of the pixels in S1, with no label included more than once.

If L1 contains zero labels, BC is an interior boundary pixel. BC should not be labeled and should be excluded from further calculations.

If L1 contains one label, pixel lister 330 labels BC with that label.

If L1 contains two labels, pixel lister 330 labels BC with the smaller of the two labels. This provides consistency in labeling boundary pixels, compared to an arbitrary assignment of one of the two labels.

If L1 contains more than two labels, BC is a border pixel at the corner of three or more regions. BC should not be labeled and should be excluded from further calculations because users do not visually interpret corner pixels as contributing to lengths of boundaries between regions but rather interpret them as being part of corners.

Any boundary pixel in the border label map 330a that has been assigned a non-zero label is still considered a boundary pixel after labeling because it corresponds to a full-white pixel in the final outline image 320a, but it is also considered part of a region in the border label map 330a because it has a non-zero label.

Pixel lister 330 results in (1) the border label map 330a, a copy of the final label map 320a with a labels assigned to most boundary pixels, interior boundary pixels and corner pixels excluded and (2) a separate list of all boundary pixel locations 330b in the border label map.

EPL 340 is a module configured to designate and list edge pixels in the border label map 330a organized by trace. EPL 340 determines edge pixel locations and organizes them by the trace each edge pixel belongs to, just as in neighbor finder 160 with the notable exception that EPL 340 only searches through the list of boundary pixel locations 330b since every edge pixel is also a boundary pixel. As in Neighbor Finder 160, any format of edge pixel locations is acceptable, such as pixel coordinates, but the preferred embodiment of EPL 340 uses a pointer value (the memory location) of the pixel in the border label map 330a, which enables quick access to the label value for that pixel.

The edge pixel locations organized by trace, hereinafter called final traces 340a, will be used in subsequent steps to determine the “strength of neighborship” between contacting regions, and then use that strength of neighborship to determine whether a given pair of contacting regions shares a long enough boundary length to be considered neighbors in the final neighbor list. Listing and organizing edge pixel locations by trace in the final traces 340a saves computational time in these subsequent steps, because rather than search through all pixels in the border label map 330a or even just in the list of boundary pixel locations 330b to determine if a pixel is an edge pixel and if so what trace it belongs to, subsequent modules can access all the pixels belonging to a given trace and their labels using the final traces 340a. EPL 340 results in the final traces 340a, or more simply, a list of edge pixel locations in the border label map 330a organized by which pair of regions each edge pixel is a border of.

Neighbor finder 350 is a module configured to create the final neighbor list 350a using the final traces 340a. Neighbor finder 350 calculates the strength of neighborship for each pair of contacting regions using the same method as disclosed hereinabove for neighbor finder 160. Neighbor finder 350 creates the final neighbor list 350a by listing each pair of contacting regions as neighbors if the strength of neighborship between them is at least “S2” pixels.

In general, the length of the boundary between regions that is clearly visually perceptible as a contiguous length of contact rather than an isolated point of contact, i.e. corner, depends on the size of the final outline image 320b and on the thickness, D, as hereinabove described, of the lines in the outline image 270a. The larger the size of the final outline image 320b, the longer the length of contact must be in pixels for a user to clearly visually identify. The thicker the lines in the outline image 270a, the longer the length of contact must be because the human brain naturally interprets isolated points along a line to have a size (length and thickness) of approximately the thickness of the line. Thus, for the human brain to easily identify a length of outline that is not an isolated point, the length of outline must be longer than the thickness of the line by some factor. Thus, the length, “L2”, of contact between two regions (and therefore the strength of neighborship between those two regions) that there must be for two regions to be listed as neighbors in the final neighbor list 350a is determined by neighbor finder 350 as follows:

Neighbor finder defines “N5” as the number of pixels total in the final outline image 320b. Experimentally, L2 is the larger of two numbers: (1) the smallest integer greater than or equal to the square root of a fraction, the numerator of which is N5, and the denominator of which is “N6”, with the value of N6 as described below, and (2) the smallest integer greater than or equal to the product of D and F, with the value of “F” as described below.

A larger value of N6 and a smaller value of F means that smaller length of contact is required for listing two regions as neighbors, while a smaller value of N6 and a larger value of F means that a larger length of contact is required for listing two regions as neighbors. Experimentally, one acceptable value of N6 that creates a final neighbor list 350a that approximates how the brain interprets regions as neighbors is 11,000. Experimentally, one acceptable value of F that creates a final neighbor list 350a that approximates how the brain interprets regions as neighbors is 2.5.

The result of neighbor finder 350 is the final neighbor list 350a, which approximates how the brain interprets regions as neighbors and is the only remaining final component in the creation of a puzzle pix from a photograph.

The puzzle pix creation system may be implemented as a computer system 410; a computer comprising several modules, i.e. computer components embodied as either software modules, hardware modules, or a combination of software and hardware modules, whether separate or integrated, working together to form an exemplary computer system. The computer components may be implemented as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

Input 416 is a module configured to obtain an image file 410a. Said image file may be from a storage device 415, the public Internet 415a, a human 415b, etc. Unlike other embodiments, the data in image file 410a is generated from a drawing, i.e. the creator of the image whether the user, a designer, etc., has complete control over the input image. For purposes of this disclosure a drawing is identical to an outline image, except that it may also indicate the presence of zones that are not part of the puzzle pix, i.e. that cannot be labeled when playing the puzzle pix. These zones and their corresponding regions will be referred to as “non-colorable” though a puzzle pix may indicate to the user that an area has been filled using textures, numbers, labels, etc., not just with colors. Similarly, an area may be referred to as “colorable” if it may be labeled by the user when playing the puzzle pix.

Since a drawing is essentially an outline image, henceforth non-boundary zones in drawings will be referred to as domains and may be referred to as “colorable” or “non-colorable”. Some elements of control that the creator of the drawing has includes: the size of the drawing, the aspect ratio of the drawing, the arrangement of domains (including the lengths by which domains have boundaries between one another), the sizes of domains, the number of domains (including the possibility that there are more than 254 domains), and the thickness of boundary outlines around domains. Input drawing 417 is a graphical representation of the image data of image file 410a. In the preferred embodiment, the following are requirements for Input Drawing 417:

1. It represents boundaries between domains with full-white pixels.

2. It represents colorable domains with grayscale pixels that are not full-white (that is, R=G=B<255). (The intended use of this is that most pixels in a colorable domain are full-black except for pixels near boundaries that may be gray to smooth the appearance of the boundary lines.)

3. It represents non-colorable domains with non-grayscale pixels (of any one or multiple colors). Non-grayscale pixels do not have R=G=B. In order for boundary outlines to be smooth around non-colorable domains, the pixels near the border pixels around non-colorable domains need to indicate what grayscale color those pixels should appear as in the final outline image of the puzzle pix. These pixels indicate that grayscale color in the R channel (in the RGB space; it could be in the Y channel in the Y′UV space, for example, though the preferred embodiment uses the RGB color space) while indicating they are non-colorable by either or both of the B and G channels having a different value than the R channel (so that these pixels have non-grayscale colors).

4. At least one of three statements is true: “M1” the line thickness used for boundaries between domains is consistent throughout the drawing, “M2” the line thickness used for boundaries between domains is consistent throughout the drawing and has been specified by the creator of the drawing, and/or “M3” the length, in pixels, of shared boundary between domains required to consider a pair of domains as neighbors is specified by the creator.

Input drawing 417 is identical to the outline image that will constitute the final puzzle pix except that pixels that are part of non-colorable domains have non-grayscale colors. In the preferred embodiment, the R channel of the input drawing 417 will become the final outline image. It is possible to represent the pixel categories mentioned above (boundaries, colorable domains, and non-colorable domains) differently by assigning a subset of the colors that can be represented in the color space used in input drawing 417 to each of the pixel categories. One of ordinary skill in the art of image processing can adapt the computer system 410 to use different color space subsets and/or different color spaces (including a grayscale color space) to represent these pixel categories by changing the steps in the computer system 410 in insubstantial ways. The approach mentioned above is the preferred way of representing these three pixel categories and has the additional benefit of allowing the creation of an outline image with smooth lines without limitation to other formulations.

Labeler 419 is a module configured to create the final label map 419a and the final outline image 419b. Labeler 419 applies a flood fill algorithm on input drawing 417 which identifies non-colorable domains, colorable domains, and boundaries by pixel value and labels the pixels in the final label map 419a in the following manner: all pixels corresponding to boundary pixels in input drawing 417 are assigned the label 0, all pixels corresponding to non-colorable domains in input drawing 417 are assigned the positive integer label “LL”, and all pixels corresponding to colorable domains in input drawing 417 are assigned an integer label other than 0 or LL, with all pixels corresponding to a given colorable domain being assigned the same label that is distinct from any other label given to pixels corresponding to other colorable domains. In the preferred embodiment of labeler 419, the value of LL is 255, and colorable domains in input drawing 417 give rise to regions in the final label map 419a that are assigned sequential integer labels starting from 1 and skipping the label LL (the label used for non-colorable regions) if at least LL regions are labeled. Non-colorable regions do not need to be distinguished from one another and will not be listed in the final neighbor list, so the single unique label LL is sufficient to represent all non-colorable regions.

There is no requirement that the puzzle pix should have at most 254 regions, and thus, additional channels in the final label map 419a may be necessary. Labeler 419 does not need to ignore small domains in the input drawing 417 since including small regions in the drawing is at the discretion of the creator. This is in contrast to a previously described exemplary embodiment of creating a puzzle pix from a photograph in which small domains were removed from outline image 270a. Furthermore, since there is no determination of which regions in the final label map 419a are small, a pixel count within regions need not be calculated.

In the preferred embodiment, the drawing's R channel is the same as the final outline image 419b. Thus, there is no need to adjust the final outline image 419b. Rather it is just copied from the R channel of the drawing. It should be noted that this copying works for the preferred embodiment, but simple and insubstantial calculations may be necessary to calculate the pixel values in the final outline image 419b if a different color system is used.

Labeler 419 creates (1) a final label map 419a with any number of colorable regions labeled with positive non-zero integers other than LL, with boundaries labeled with the special label 0, and with non-colorable regions all labeled with the special value LL and (2) a final outline image 419b which, in one embodiment, is identical to the R channel of the drawing. These two things are two of the three components that constitute the final puzzle pix. The remaining component is the final neighbor list which the subsequent steps will create.

Pixel lister 420 is a module configured to list and label boundary pixels in the border label map 420a. This step is as previously described for pixel lister 330 except for the following adjustments:

The special label for non-colorable regions LL is not treated any differently than any other non-zero positive region label. Where appropriate, it is assigned as a label to boundary pixels using the same rules as for assigning other labels.

Because no small domains were ignored in creating the final label map 419a there is no such thing as an “interior boundary pixel.” As such, there is no reason to limit the search for the closest pixel in the final label map 419a with a non-zero positive label to the radius r. This means that every non-corner boundary pixel in the resulting border label map 420a will be assigned a non-zero positive label. Not limiting the search to within a certain radius does not cause a significant performance degradation because typically the vast majority of boundary pixels have a closest pixel of non-zero positive label that is not more distant than half the thickness of boundary outlines used in the input drawing image 417. This is true since small domains were not converted to boundary pixels and thus only the relatively thin outlines contain boundary pixels, with each of these boundary pixels not being more distant than half the thickness of the boundary outlines used in the input drawing 417, except possibly when they are near corner points between three or more regions.

Pixel lister 420 creates (1) the border label map 420a (a copy of the final label map 419a with most boundary pixels having been assigned a positive non-zero label except for corner pixels and, as previously described with pixel lister 330, (2) a separate list of boundary pixel locations 420b in the border label map. EPL 430 is a module configured to list edge pixels by the trace and is identical to EPL 340 except that EPL 430 counts edges pixels as they are identified and organized into final traces 430a. A given edge pixel may belong to multiple traces, so the total count is not equivalent to the sum of the lengths of the traces, i.e. the count of pixels in the traces; rather it is just the total number of edge pixels.

Neighbor finder 440 is a module configured to create a final neighbor list 440a and is identical to neighbor finder 350 except for the following adjustments:

The creator of input drawing 417 could optionally specify L2. If L2 was specified, i.e. M3 is true, there is no need to calculate a value of L2 and the specified value is used to determine which regions constitute neighbor pairs and will be listed in the final neighbor list 440a.

If the creator did not specify L2, but specified the value of D, i.e. M2 is true and M3 is not true, that value of D is used by neighbor finder 440.

If the creator specified neither L2 nor D, i.e. neither M2 nor M3 is true, then as per the fourth requirement of the drawing as mentioned above, the line thickness of region boundaries used in the input drawing 417 is known to be consistent, i.e. M1 is true. The specific thickness of lines used in the input drawing 417, D, must be estimated. Neighbor finder 440 estimates D as the average outline thickness throughout input drawing 417 by dividing the total number of boundary pixels (the number of pixels in the list of boundary pixel locations 420b) by a fraction, the numerator of which is the total number of edge pixels in the border label map 420a (which was calculated EPL 430), and the denominator of which is 2. Mathematically, D≈b/(e/2)=2b/e, where b is the total number of boundary pixels, and e is the total number of edge pixels. In essence, half the number of edge pixels is a good estimate of the length of all the boundaries in input drawing 417. Dividing the total number of boundary pixels by the total length of the boundaries in input drawing 417 gives the estimated thickness of the outline lines D. The reason for using half of the number of edge pixels in this calculation is that every edge pixel contacts at least one edge pixel belonging to a different region, and thus along the borders between regions there is a single-pixel thick line of edge pixels on either side. That is, if one were to draw just the edge pixels, the lines would appear two pixels thick on average and thus the length of the outlines in the input drawing 417 is the number of edge pixels divided by 2. This process gives an estimate for D that when used to calculate the minimum strength of neighborship required for a pair of regions to be listed in the final neighbor list 440a, creates a final neighbor list 440a that corresponds well to how the brain naturally determines which regions are neighboring by a contiguous length of boundary rather than by disjoint points.

Final neighbor list 440a is remaining final component in the creation of a puzzle pix from a drawing.

We claim:

1. An exemplary computer system configured to create a puzzle pix comprising a first module configured to receive an input file, where said input file contains an image; a second module configured to resize said image to generate a puzzle pix; a third module configured to convert equalize said image, a fourth module configured to blur said image; a fifth module configured to segment said image; a sixth module configured to smooth said image; a seventh module configured to label regions within said image; an eighth module configured to designate neighbor pairs within said image; a ninth module configured to determine the strength of neighborship for each neighbor pair; a tenth module to merge regions within said image; an eleventh module configured to change the difficulty of the generated puzzle pix; and a twelfth module configure to determine identify neighbor pairs.
